(19) United States
(12) Patent Application Publication
(10) Pub. No.: US 2017/0319942 A1
(43) Pub. Date: Nov. 9, 2017

(54) ATHLETIC GLOVE

(71) Applicant: John Miller, Livonia, MI (US)

(72) Inventor: John Miller, Livonia, MI (US)

(21) Appl. No.: 15/584,578

(22) Filed: May 2, 2017

Related U.S. Application Data
(60) Provisional application No. 62/331,702, filed on May 4, 2016.

(51) Int. Cl. A63B 71/14; A41D 19/015

(52) U.S. Cl. CPC A63B 71/141; A41D 19/01558; A61H 2205/065; A63B 2243/007; A61H 2205/067

(57) ABSTRACT

An athletic glove is provided for an athlete participating in a sport or competition. The athletic glove includes specifically designed finger receptacles for enhanced stability and protection for the athlete's fingers and improved performance. A first finger receptacle encloses the little and ring fingers preventing them from moving relative to each other. A second finger receptacle encloses the index and middle finger thus preventing them from moving relative to each other.

### CROSS REFERENCE TO RELATED APPLICATIONS

This application claims benefit of U.S. Provisional Application No. 62/331,702 filed May 4, 2016. The disclosure of the above application is incorporated herein by reference.

### FIELD

The present disclosure relates to athletic equipment and apparel, and more specifically to protective and performance enhancing football gloves.

### BACKGROUND

The statements in this section merely provide background information related to the present disclosure and may or may not constitute prior art.

Typical football equipment includes padded pants, shoulder pads, and helmets among other protective or performance enhancing equipment. Football gloves are particularly important because they serve a dual function of protecting the players hands while improving the ability of the player in catching, holding, and throwing the football. As with other pieces of equipment, football gloves are tailored to particular player positions. For example, receiver's gloves include special materials that improve the players grip on the football in less than ideal weather conditions. Alternatively, linemen wear gloves that include padding intended to help prevent injuries.

While current forms of football gloves help improve player performance and provide protection against some injuries, there is a need for an improved football glove that advances performance while preventing new injuries and help previous injuries from getting worse or possibly even aid in healing.

### SUMMARY

The present invention provides an athletic glove having a plurality of finger receptacles, a thumb receptacle, a closing system, a palm surface, and a backhand surface.

Further features and advantages of the present disclosure will become apparent by reference to the following description and appended drawings wherein like reference numbers refer to the same component, element or feature.

### DRAWINGS

The drawings described herein are for illustration purposes only and are not intended to limit the scope of the present disclosure in any way;

FIG. 1 is a is a top view of the backhand of an athletic glove according to the present disclosure;

FIG. 2 is a side view of an athletic glove according to the present disclosure;

FIG. 3 is a cross-sectional view of an athletic glove according to the present disclosure;

FIG. 4 is a palm view of a right and left hand athletic glove according to the present disclosure; and

FIG. 5 is a cross-sectional view of a portion of an athletic glove according to the present disclosure.

### DETAILED DESCRIPTION

The following description is merely exemplary in nature and is not intended to limit the present disclosure, application, or uses.

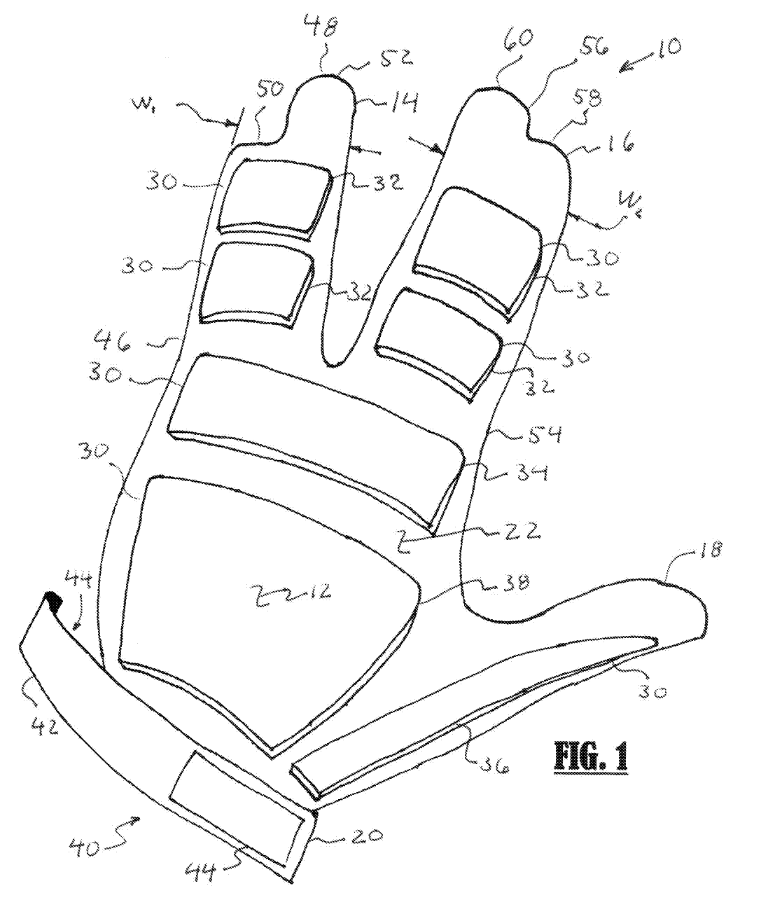

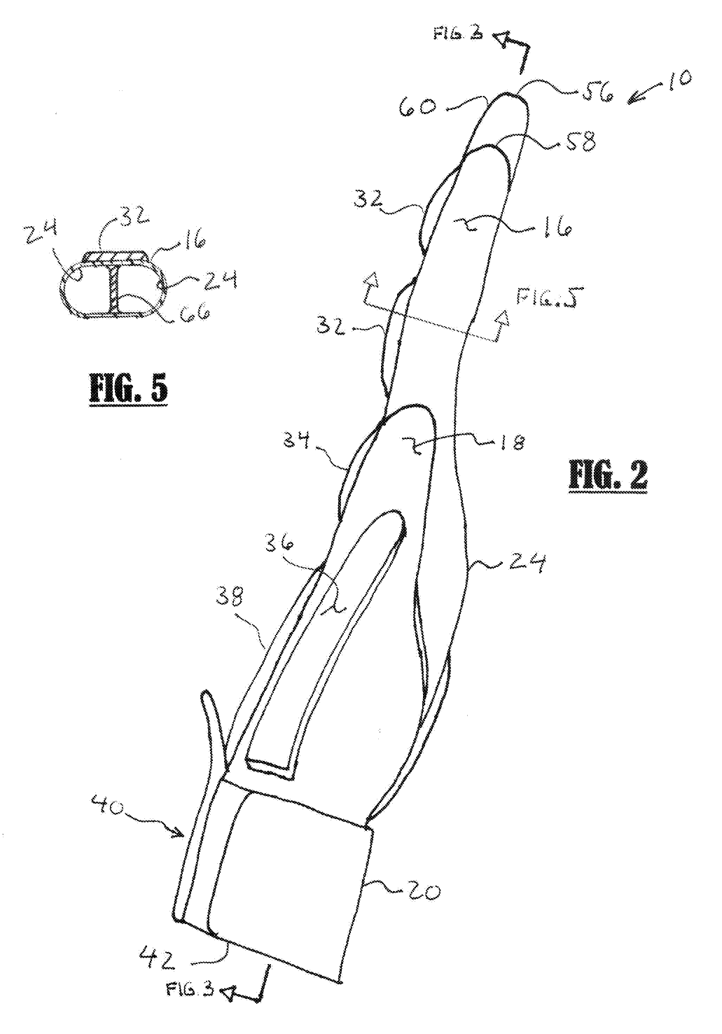

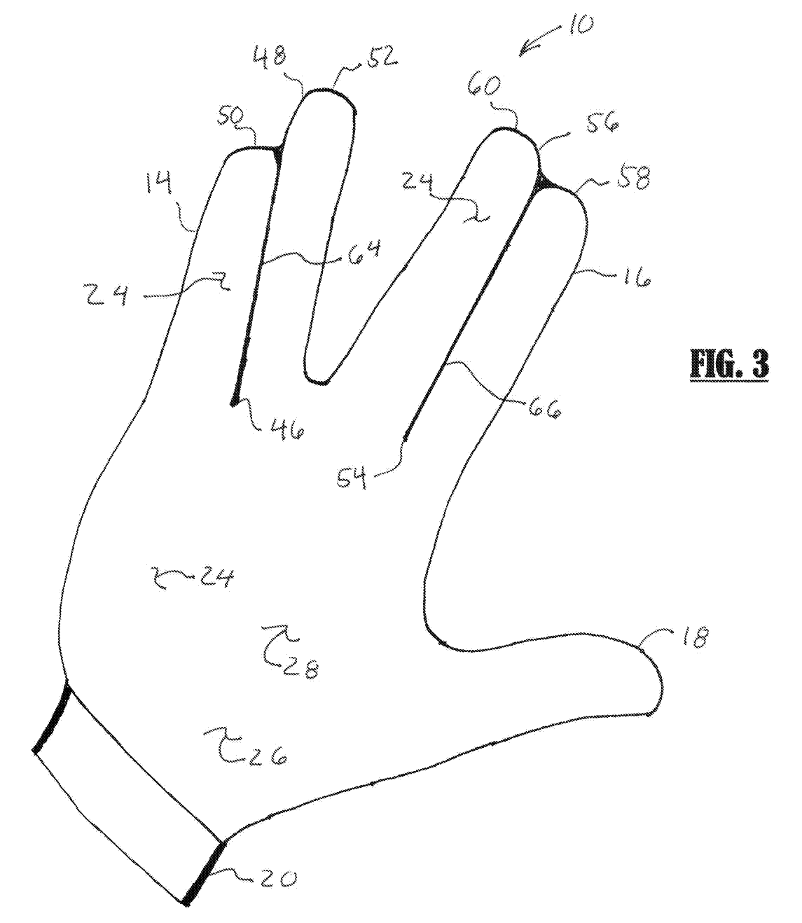

With reference to FIG. 1, an exemplary an athletic glove 10 is illustrated and will now be described. The athletic glove 10 includes a palm portion 12, a first finger receptacle 14, a second finger receptacle 16, a thumb receptacle 18, and a cuff 20. More specifically, the athletic glove 10 is generally assembled from several pieces of material. For example, a backhand 20 of the athletic glove may be a single first section 22 of material that forms a backhand portion of each of the palm portion 12, the first finger receptacle 14, and the second finger receptacle 16. Additionally, the forehand 24 of the athletic glove may be a single second section 26 (more appropriately viewed in FIG. 2) of material that forms a forehand portion of each of the palm portion 12, the first finger receptacle 14, and the second finger receptacle 16. Thus, the first section 22 and second section 26 of material may be formed from one or more layers of material, such as lycra, leather, neoprene, nylon, synthetic leather, and the like, and are joined by methods known in the art, such as sewing, knitting, and the like, to form a cavity 28 (more precisely shown in FIG. 3) for receiving the athlete's hand. Therefore, the first and second finger receptacles 14, 16 and the thumb receptacle 18 combine to form the cavity 28. In one example of the present invention, the second section 26 of material of the forehand 24 of the athletic glove is an outwardly facing abrasion resistant high tack material to enhance the athlete's grip. In other examples, the backhand 20 includes pads 30 having additional layers of material in specific areas to provide additional protection against impact to the bones of the hand. In particular, the pads 30 may include finger pads 32, a knuckle pad 34, a thumb pad 36, and a backhand pad 38.

The first and second finger receptacles 14, 16 and thumb receptacle 18 extend from the palm portion 12. The width of each of the first and second finger receptacles 14, 16 is wide enough to receive two adjacent fingers of the athlete's hand. The width W1 of the first finger receptacle 14 is wide enough to receive each of the little and ring fingers of the athlete's hand. Likewise, the width W2 of the second finger receptacle 16 is wide enough to receive each of the index and middle fingers of the athlete's hand. The thumb receptacle 18 is sized to receive the thumb. However, other examples of the athletic glove that include a finger receptacle that is wide enough to receive three fingers does not fall outside the scope of the present invention.

The cuff 20 of the athletic glove includes a closing mechanism 40 as well as other protective features. The closing mechanism 40 is disposed on the cuff 20 to securely fix the athletic glove 10 to the athlete's hand. The closing mechanism 40 includes a strap 42 having a portion of a hook-and-loop fastening system 44 to enclose and tighten the wrist cuff 20 around the wrist of the athlete. However, other types of fastening systems may be utilized to secure the athletic glove 10 to the hand of the athlete without departing from the scope of the invention. For example, snap buttons or a strap buckle, among other methods, may be used as the closing mechanism 40.

The first finger receptacle 14 includes a first end 46 and a second end 48. The first end 46 of the first finger receptacle 14 is fixed to the palm portion 12 as the second end 48 extends outwardly from the palm portion. The second end 48 terminates in two lengths such that the second end 48 fits tightly to each of the little finger and ring finger given the differing lengths of the two fingers. A first length 50 tightly fits to the end of the little finger with the second length 52 tightly fitting to the end of the ring finger of the athlete's hand. Similarly, the second finger receptacle 16 includes a first end 54 and a second end 56. The first end 54 of the second finger receptacle 16 is fixed to the palm portion 12 between the first finger receptacle 14 and the thumb receptacle 18. The second end 56 of the second finger receptacle 14 also terminates in two lengths such that the second end 56 fits tightly to each of the middle finger and the index finger given the differing lengths of the two fingers. A first length 58 tightly fits to the end of the index finger with the second length 60 of the second end 56 of the second finger receptacle 16 tightly fitting to the end of the middle finger of the athlete's hand.

Turning now to FIGS. 2, 3 and 5, a side view of the athletic glove 10 is depicted in FIG. 2 with cross-sections of an interior structure 62 of the athletic glove 10 illustrated in FIGS. 3 and 5. Thus, the interior structure 62 of the athletic glove 10 will now be described. The first and second finger receptacles 14, 16 of the athletic glove 10 each include a finger web 64, 66. More specifically, the first finger receptacle 14 includes the finger web 64 disposed proximate the center of the width of the first finger receptacle 14 and extends from the first end 46 to connect to the second end 48 of the first finger receptacle 14. The finger web 64 further connects the backhand 20 to the forehand 24 of the first finger receptacle 14 separating the little finger from contacting the ring finger. The second finger receptacle 16 includes the finger web 66 disposed proximate the center of the width of the second finger receptacle 16 and extends from the first end 54 to connect to the second end 56 of the second finger receptacle 16. The finger web 66 further connects the backhand 20 to the forehand 24 of the second finger receptacle 16 separating the index finger from contacting the middle finger. The finger webs 64, 66 provide the capability for slight movement between the fingers without skin-to-skin friction thus preventing blisters or other skin injuries.

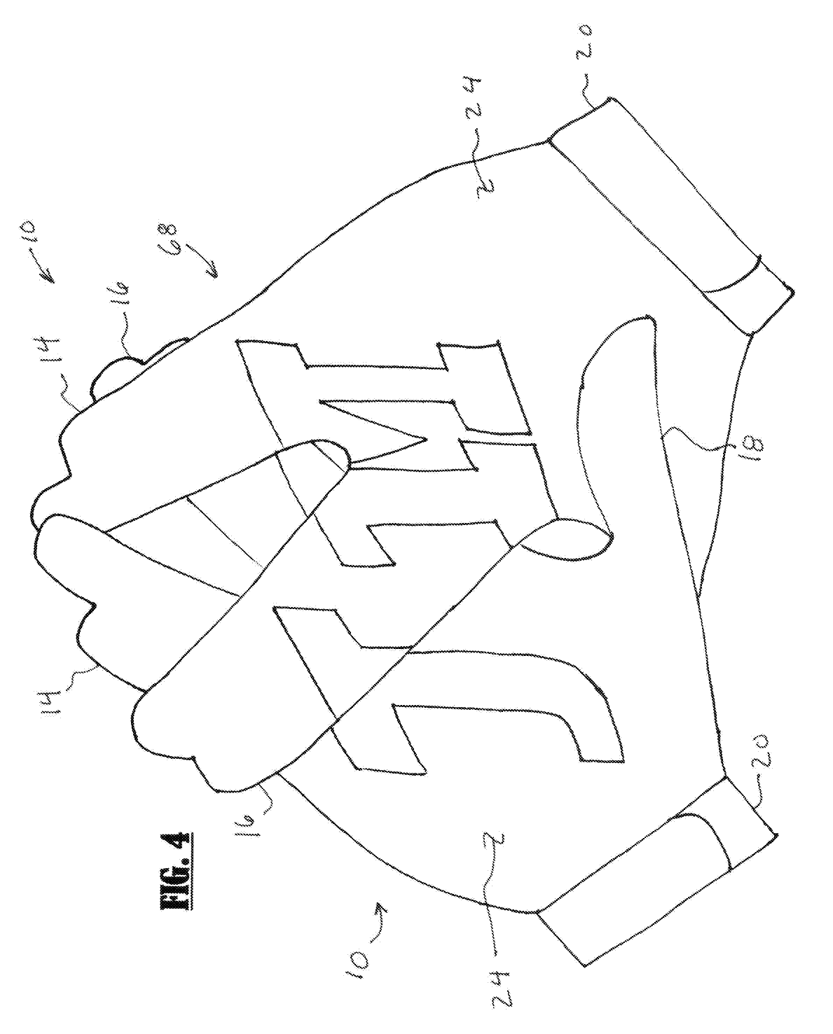

Referring now to FIG. 4, another example of the athletic glove 10 is illustrated as a pair and will now be described. The forehand 24 and backhand 20 may include specialized materials to improve performance and protection. Additionally, the forehand 24 and backhand 20 may be configured to include designs such as team logos 68 or mascots. The covers may also include special reinforcing straps or materials to improve the stability of the athletic glove and more importantly the athlete's hand within the athletic glove.

The athletic glove may also include additional features without departing from the scope of the invention. In particular, protective features that prevent the hyperextension or otherwise mis-movement of the several joints of the athlete's hand, fingers, thumb and wrist may be incorporated into the athletic glove.

The description of the invention is merely exemplary in nature and variations that do not depart from the gist of the invention are intended to be within the scope of the invention. Such variations are not to be regarded as a departure from the spirit and scope of the invention.

I claim:

1. A protective glove for an athlete, the protective glove comprising a palm portion, a first finger receptacle, a second finger receptacle, and a thumb receptacle, and wherein the first finger receptacle receives at least a first and a second fingers of a hand of the athlete.

2. The protective glove of claim 1 wherein the second finger receptacle receives at least a third and a fourth fingers of the hand of the athlete.

3. The protective glove of claim 1 further including a backhand section and a forehand section, and wherein the backhand section covers a back of the hand of the athlete and includes a backhand portion of each of the palm portion, the first and second finger receptacles, and the thumb receptacle, and the forehand section covers a palm of the hand of the athlete and includes a forehand portion of each of the palm portion, the first and second finger receptacles, and the thumb receptacle.

4. The protective glove of claim 3 wherein the backhand section includes at least one pad disposed on each of the first and second finger receptacles, the palm portion, and the thumb receptacle.

5. The protective glove of claim 3 wherein the palm portion of the forehand section includes a pad.

6. The protective glove of claim 3 wherein the first finger receptacle includes a web disposed lengthwise in the first finger receptacle between the at least first and second fingers of the hand of the athlete and fixed to each of the forehand portion and the backhand portion of the first finger receptacle.

7. The protective glove of claim 3 wherein the second finger receptacle receives at least a first and a second finger of the hand of the athlete and the first finger receptacle and the second finger receptacles each include a web disposed lengthwise in the first and second finger receptacles between the at least first and second fingers and third and fourth fingers, respectively, of the hand of the athlete and fixed to each of the forehand portion and the backhand portion of the first and second finger receptacles.

8. The protective glove of claim 1 further including a cuff having a closing mechanism, and wherein the cuff is attached to the palm portion opposite the first and second finger receptacles and receives a wrist of the athlete.

9. The protective glove of claim 8 wherein the closing mechanism includes a hook-and-loop fastening system.

10. A protective glove for an athlete, the protective glove comprising a palm portion, a first finger receptacle, a second finger receptacle, a thumb receptacle, a backhand section, and a forehand section, and wherein the backhand section covers a back of the hand of the athlete and includes a backhand portion of each of the palm portion, the first and second finger receptacles, and the thumb receptacle, the forehand section covers a palm of the hand of the athlete and includes a forehand portion of each of the palm portion, the first and second finger receptacles, and the thumb receptacle, the first and second finger receptacles each receives at least two fingers of a hand of the athlete, the first finger receptacle and the second finger receptacles each include a web disposed lengthwise in the first and second finger receptacles between the at least two fingers of the hand of the athlete and fixed to each of the forehand portion and the backhand portion of the first and second finger receptacles, respectively.

11. The protective glove of claim 10 wherein the backhand section includes at least one pad on the first and second finger receptacles, the palm portion, and the thumb receptacle.

12. The protective glove of claim 11 wherein the palm portion of the forehand section includes a pad.

13. The protective glove of claim 12 further including a cuff having a closing mechanism, and wherein the cuff is attached to the palm portion opposite the first and second finger receptacles and receives a wrist of the athlete.

14. The protective glove of claim 13 wherein the closing mechanism includes a hook-and-loop fastening system.

15. A protective glove for an athlete, the protective glove comprising a palm portion, a first finger receptacle, a second finger receptacle, a thumb receptacle, a backhand section, and a forehand section, and wherein the backhand section covers a back of the hand of the athlete and includes a backhand portion of each of the palm portion, the first and second finger receptacles, and the thumb receptacle, the forehand section covers a palm of the hand of the athlete and includes a forehand portion of each of the palm portion, the first and second finger receptacles, and the thumb receptacle, a width of the first finger receptacle is sized to receive each of a little finger and a ring finger of a hand of the athlete, a width of the second finger receptacle is sized to receive an index finger and a middle finger of the hand of the athlete, the first finger receptacle includes a first web disposed lengthwise in the first finger receptacle between the little finger and ring finger, the second finger receptacle includes a second web disposed lengthwise in the second finger receptacle between the middle finger and index finger of the hand of the athlete, and each of the first and second webs are each fixed to the forehand portion and the backhand portion of the first and second finger receptacles, respectively.

16. The protective glove of claim 15 wherein the backhand section includes at least one pad disposed on the first and second finger receptacles, the palm portion, and the thumb receptacle.

17. The protective glove of claim 15 wherein the palm portion of the forehand section includes a pad.

18. The protective glove of claim 17 further including a cuff having a closing mechanism, and wherein the cuff is attached to the palm portion opposite the first and second finger receptacles and receives a wrist of the athlete.

19. The protective glove of claim 18 wherein the closing mechanism includes a hook-and-loop fastening system.

20. The protective glove of claim 15 wherein the first and second finger receptacles each have a first end and a distal end opposite the first end and the distal end of the first and second finger receptacles are open allowing each of the fingers of the athlete to pass through the distal end of the first and second finger receptacles.
